(19) United States
(12) Patent Application Publication
(10) Pub. No.: US 2008/0171462 A1
(43) Pub. Date: Jul. 17, 2008

(54) Card connector capable of securing the card

(75) Inventor: Chin-Hwa Wu, Taoyuan County (TW)

Correspondence Address: BACON & THOMAS, PLLC, 625 SLATERS LANE, FOURTH FLOOR, ALEXANDRIA, VA, 22314, US

(73) Assignee: TAI-SOL ELECTRONICS CO., LTD., TAIPEI CITY (TW)

(21) Appl. No.: 11/790,320

(22) Filed: Apr. 25, 2007

(30) Foreign Application Priority Data
Jan. 12, 2007 (TW) 96200702

(51) Int. Cl. H01R 13/62

(52) U.S. Cl. 439/325

(57) ABSTRACT

A card connector, which may secure a card inserted therein, includes a housing, a sliding block and a lock hook. The housing includes a substrate with a slot. The sliding block is received in the slot for reciprocation along the slot. The lock hook includes a main member, a curved fixing piece projected from a rear of the main member and a curved lock portion projected upwardly from a front of the main member. The substrate has a protrusion at a second side thereof adjacent to the fixing terminal portion and a front space and a rear space at opposite sides of the protrusion. The main member of the lock hook is on the protrusion. The present invention may secure the card inserted therein firmly and is thinner and more flexible in space design.

### BACKGROUND OF THE INVENTION

1. Field of the Invention

The present invention relates generally to an electronic card connector, and more particularly to a card connector capable of securing the card inserted therein.

2. Description of the Related Art

A conventional electronic card connector, as disclosed in Taiwan Patent No. 568424, provides a base with a rail on a right side thereof. The rail has a slot on a center thereof. A secure device, which has a lock member with a protrusion at a front on a bottom thereof, is mounted on the rail for reciprocation along the rail.

While an electronic card is inserted into the card connector, the electronic card will press the protrusion downward into the slot so that the electronic card will cross the protrusion. While the butt side presses the pushing face, the protrusion will enter the lock hole. When keep pushing the electronic card, the electronic card will move the secure device backwards together with the lock device, and the protrusion comes out from the slot and climbs on the rail. In this time, the protrusion is still in the lock hole. Because the rail supports the protrusion, the protrusion will not easy to eject the lock hole to secure the electronic card firmly.

### SUMMARY OF THE INVENTION

The primary objective of the present invention is to provide a card connector, which can secure the inserted card therein with a different way from the prior art.

The secondary objective of the present invention is to provide a card connector, which a thinner design and a flexible space design.

According to the objectives of the present invention, a card connector, which may secure a card inserted therein, includes a housing, a sliding block and a lock hook. The housing includes a substrate with a fixing terminal portion to mount a plurality of terminals thereon on a first side and a slot. The sliding block, which has a pushing face to be acted with the card, is received in the slot to be moved between an insert position and a eject position along the slot. The lock hook includes a main member, a curved fixing piece projected from a rear of the main member and provided on the sliding block and a curved lock portion projected upwardly from a front of the main member. The substrate has a protrusion at a second side thereof adjacent to the fixing terminal portion and a front space and a rear space at opposite sides of the protrusion. The main member of the lock hook is on the protrusion, and the main member of the lock hook leans on the protrusion and the lock portion is adjacent to the protrusion when the sliding block is moved to the insert position, and a rear section of the main member of the lock hook is on the protrusion and a front section thereof is in the front space and suspended when the sliding block is moved to the eject position.

With the structure above, the present invention may secure the card firmly, furthermore, the present invention may be thinner and more flexible in space design.

### BRIEF DESCRIPTION OF THE DRAWINGS

FIG. 1 is a perspective view of a first preferred embodiment of the present invention;

FIG. 2 is a perspective view of the first preferred embodiment of the present invention, showing the bottom side;

FIG. 3 is an exploded view of the first preferred embodiment of the present invention, wherein the sliding block is up-side-down;

FIG. 4 is a perspective view of the first preferred embodiment of the present invention, wherein a part of the housing is eliminated to show the inside;

FIG. 5 is a perspective view of the first preferred embodiment of the present invention, showing the position of the lock hook;

FIG. 6 is a sketch diagram of the first preferred embodiment of the present invention, showing the card inserted;

FIG. 7 is a sectional view along the 7-7 line of FIG. 6;

FIG. 8 is a sketch diagram of the first preferred embodiment of the present invention, showing the interaction of card and the lock portion;

FIG. 9 is a sectional view along the 9-9 line of FIG. 8;

FIG. 10 is a sketch diagram of the first preferred embodiment of the present invention, showing the card inserted to the deepest position;

FIG. 11 is a sectional view along the 11-11 line of FIG. 10;

FIG. 12 is an exploded view of a second preferred embodiment of the present invention, wherein the sliding block is up-side-down;

FIG. 13 is a sketch diagram of the second preferred embodiment of the present invention, showing the card inserted;

FIG. 14 is a sectional view along the 14-14 line of FIG. 13; and

FIG. 15 is a sketch diagram of the second preferred embodiment of the present invention, showing the card inserted to the deepest position.

### DETAILED DESCRIPTION OF THE INVENTION

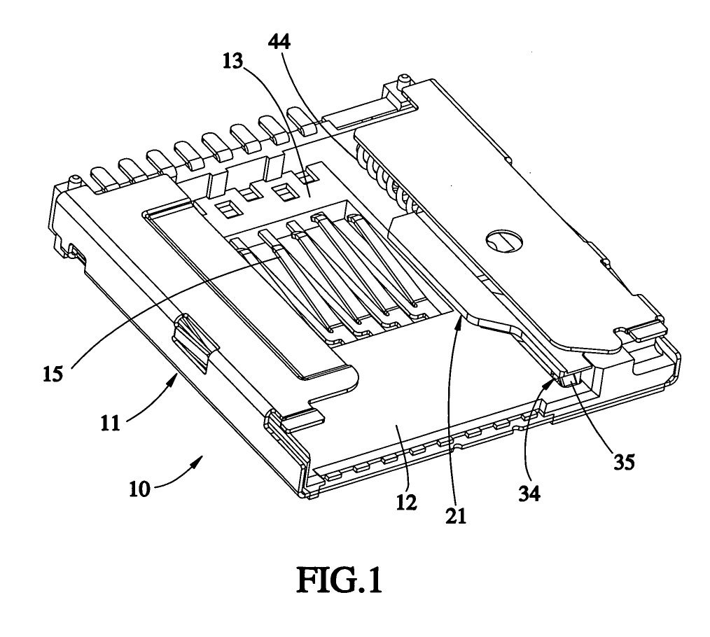

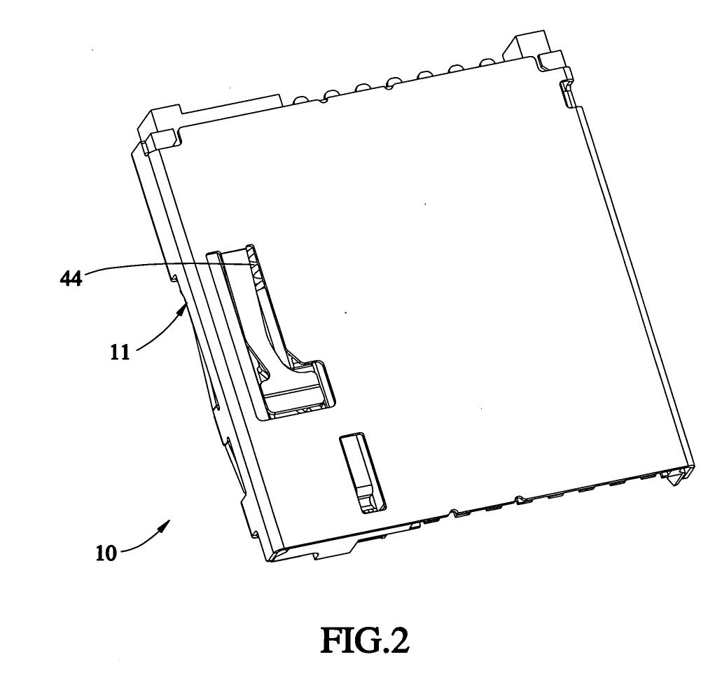

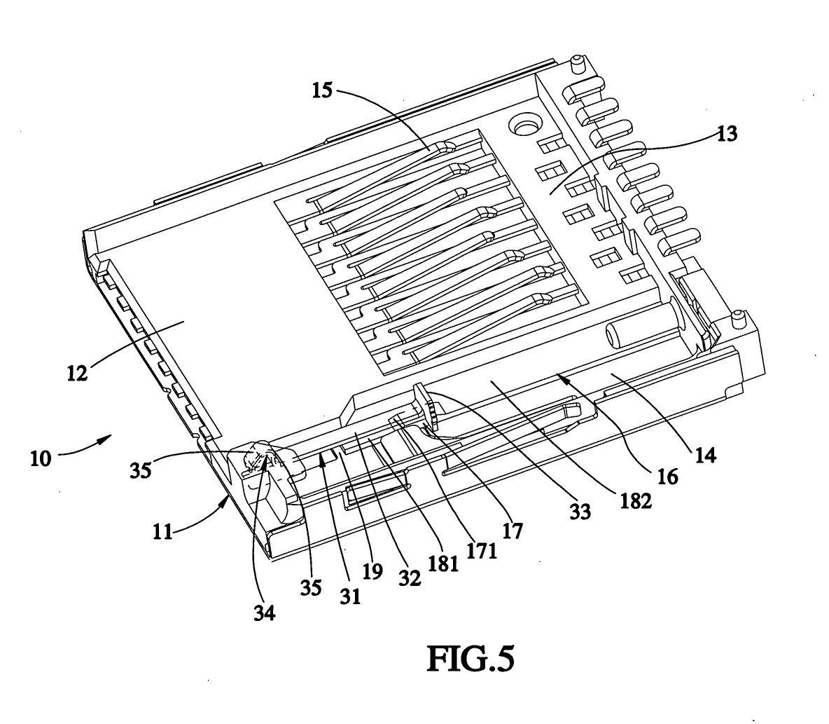

As shown in FIG. 1 to FIG. 5, a card connector 10 of the first preferred embodiment of the present invention mainly includes a housing 11, a sliding block 12 and a lock hook 31.

The housing 11 has a substrate 12. The substrate 12 has a fixing terminal portion 13 with a plurality of terminals 15 on a first side (the right side) and a slot 14.

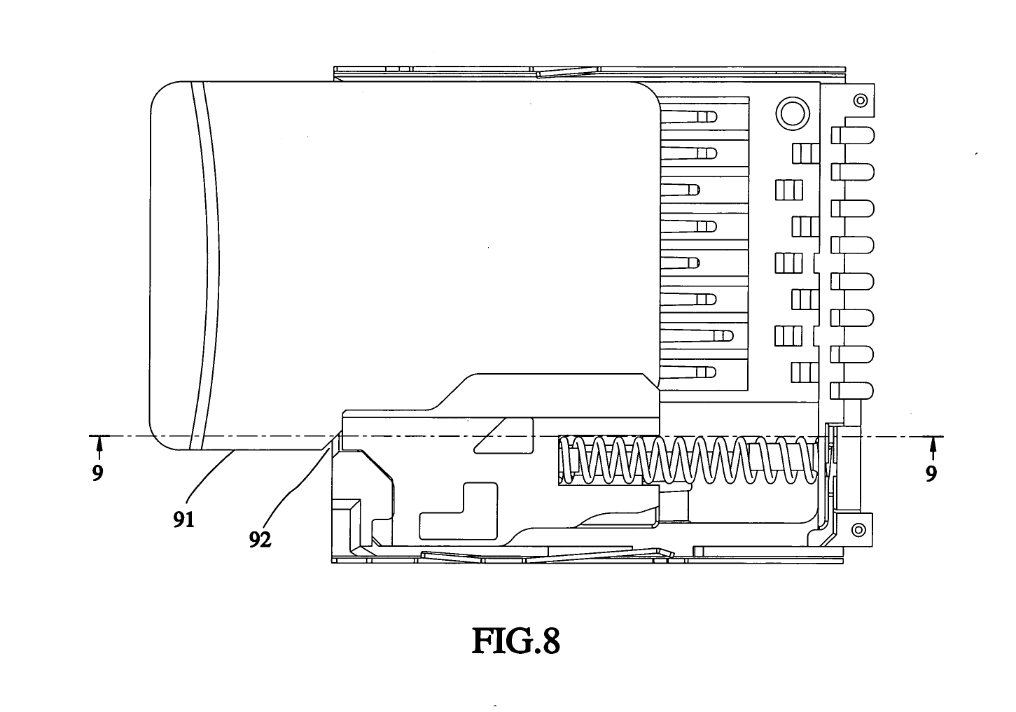

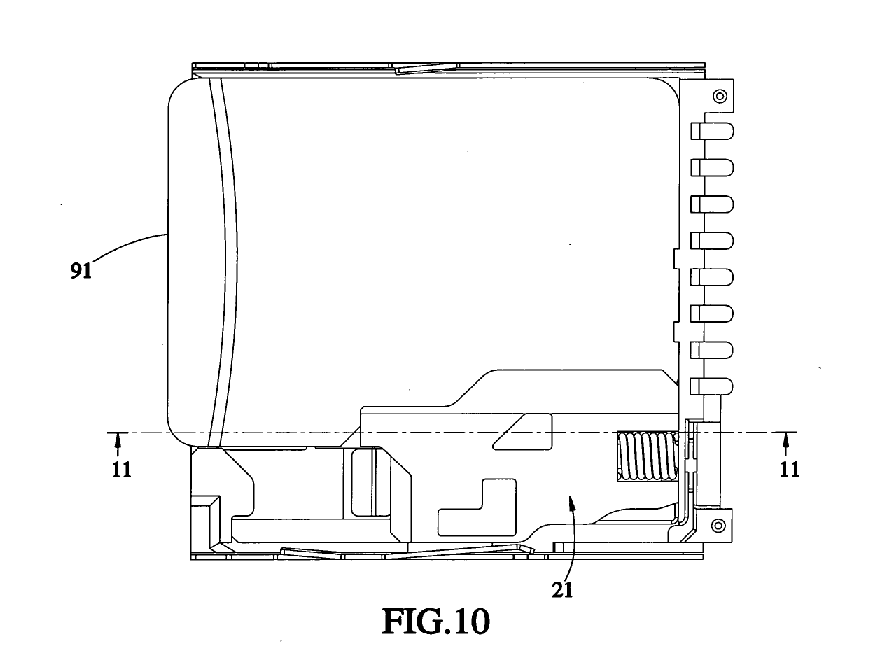

The sliding block 21 is received in the slot 14 for reciprocation between an insert position (as shown in FIG. 10) and a eject position (as shown in FIG. 8). The sliding block 21 has a pushing face 22 for action with a card (not shown).

The lock hook 31 has a main member 32, a curved fixing piece 33 on a back of the main member 32, and a lock portion 34 projected upwards from a front of the main member 32. The fixing piece 33 is fixed on the main member 32, and the lock portion 34 is a lock hook-like member with two inclined face 35 sloping downward at a front and rear side thereof.

The substrate 12 further has a vertical table 16, on which a protrusion 17 is provided, at a second side (the right side) adjacent to the fixing terminal portion 13. The protrusion 17 substantially is on the table 17 and separates the table 17 into a front space 181 and a rear space 182. The front and rear spaces 181 and 182 substantially are on the table 16. The main member 32 of the lock hook 32 is on the protrusion 17. The protrusion 17 has an inclined face 171 at a front thereof. The table 16 has a hollow portion 19 in front of the protrusion 17.

While the sliding block 21 is moved to the insert position, the main member 32 of the lock hook touches the protrusion, and the lock portion 34 is adjacent to the protrusion 17. While the sliding block 21 is moved to the eject position, the main member 32 of the lock hook 31 is above the protrusion 17, and a front section thereof is in the front space 181 and suspended.

The present invention provides an auto-eject device 41, which has a guiding shaft 42, a spring 44 and a heart-like guiding slot 46. The heart-like guiding slot 46 is provided on a bottom of the sliding block 21. The spring 44 and the guiding shaft 42 are provided between the housing 11 and the sliding block 21. The auto-eject device 41 is a conventional device and is not the main character of the present invention so that we do not describe the detail thereof.

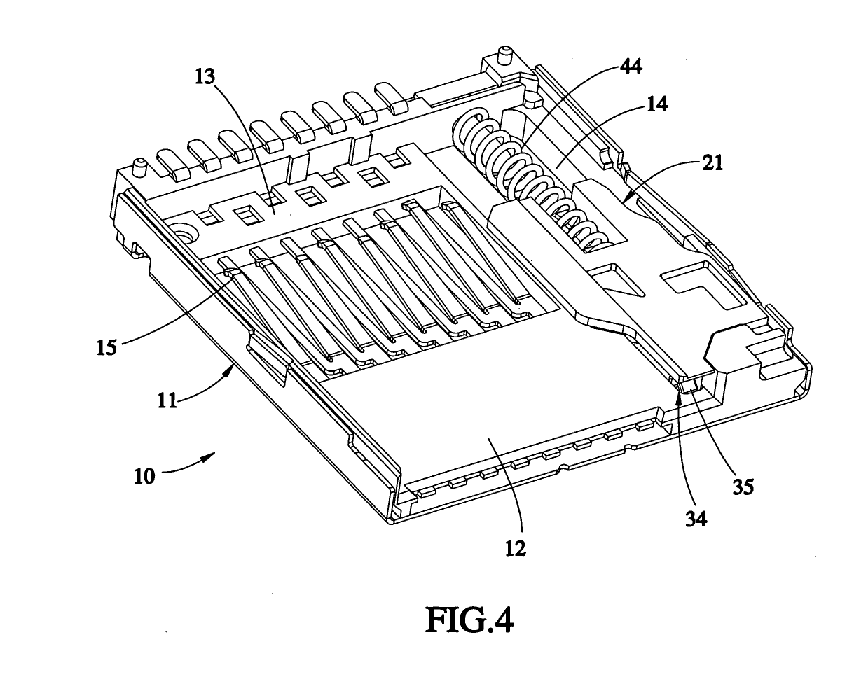

FIG. 4 shows the card connector 10 of the first embodiment without the card inserted.

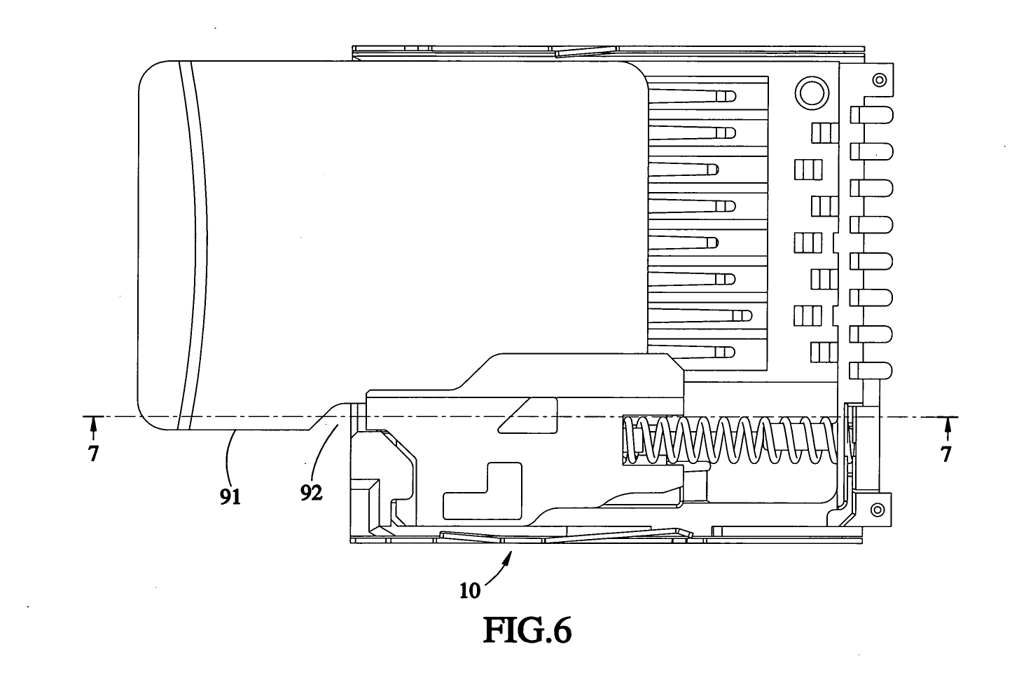

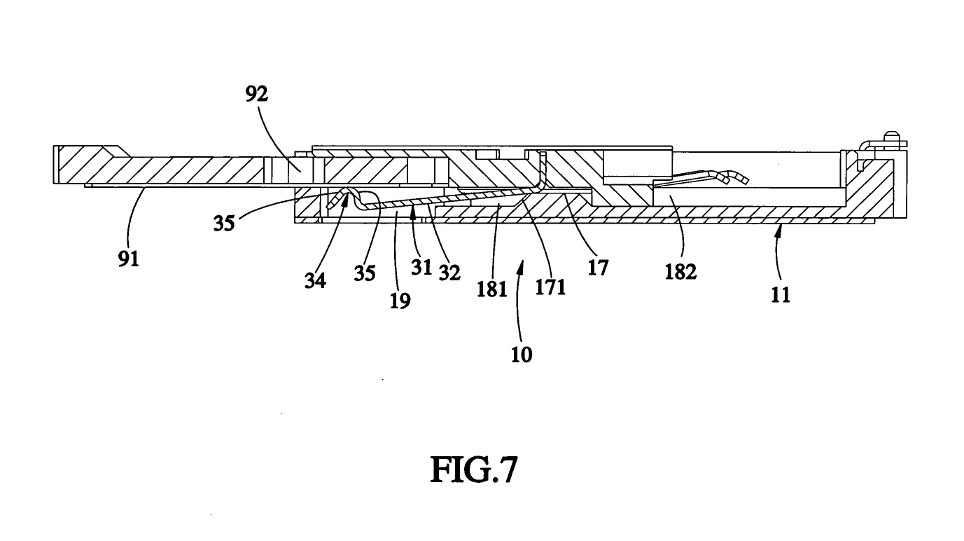

While a card 91 is inserted into the card connector 10 and the card 91 has just entered, as shown in FIG. 6 and FIG. 7, a front end of the card 91 presses the inclined face 35 of the lock portion 34 to move the lock hook 31 downward. And then, if user keeps pushing the card 91 in, the main member 32 of the lock hook 31 together with the lock portion 34 will be pressed under the card 91 and enter the front space 181 and the hollow portion 19 and rest on the inclined face 171 as well.

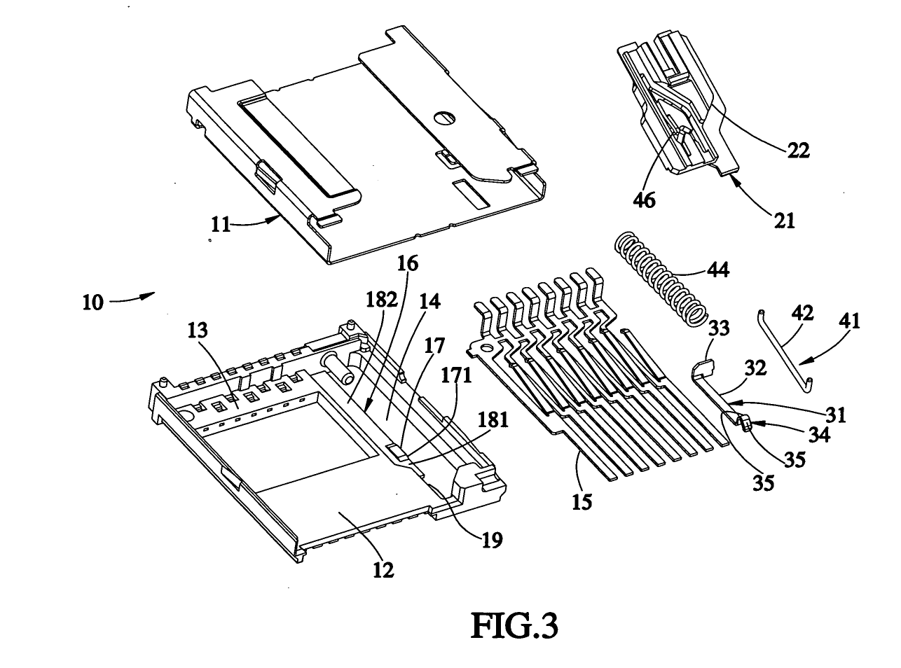

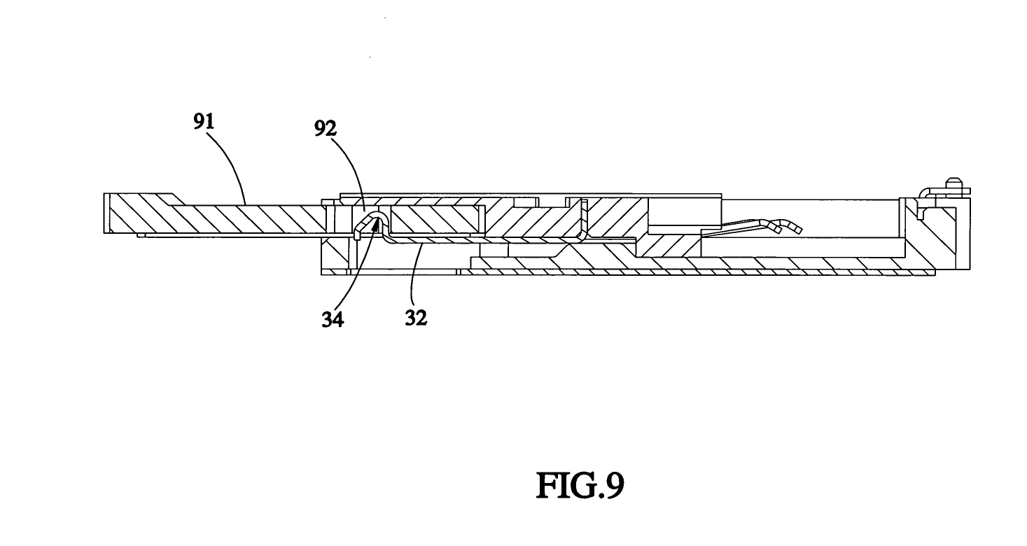

As shown in FIG. 8 and FIG. 9, when the card 91 keeps being pushed in until a lock hole 92 of the card is above the lock portion 34, the recovery force of the main member 32 will move the lock portion 34 entering the lock hole 92. In the same time, an inclined end of the card 91 leans on the pushing face 22, as shown in FIG. 3.

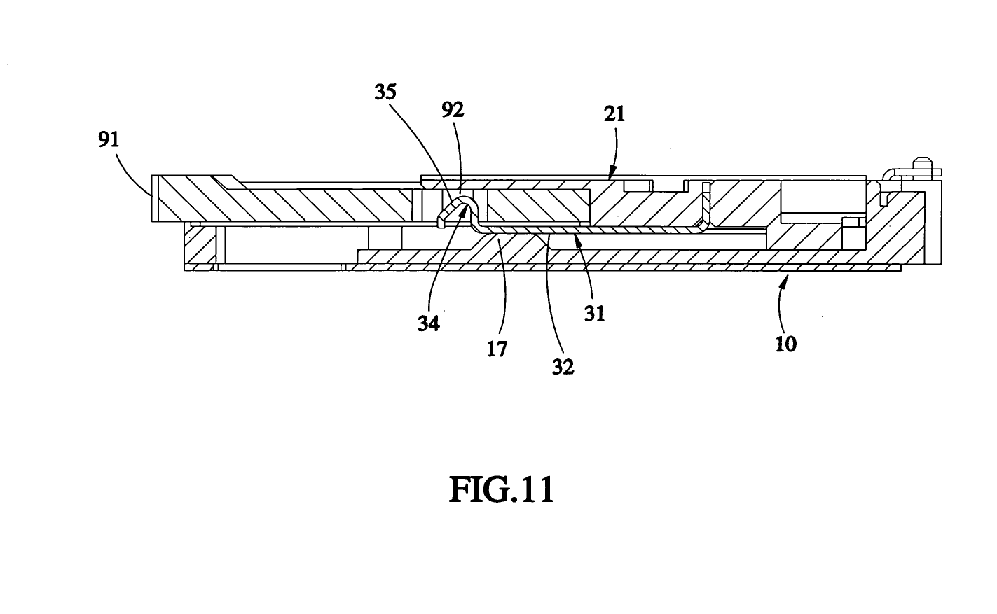

As shown in FIG. 10 and FIG. 11, while the card 91 keeps being pushed in to the deepest position, the sliding block 21 and the lock hook 31 are moved backward to the insert position. At this time, the main member 32 of the lock hook 31 leans on the protrusion 17, and the lock portion 34 is adjacent to the protrusion 17. As a result, a front section of the main member 32 of the lock portion 34 is locked between the protrusion 17 and the card 91 so that the main member 32 will not swing up and down to keep the lock portion 34 locked in the lock hole 92 when the card connector 10 is vibrated or shaken so that the card 91 will be secured in the card connector 10.

As shown in FIG. 6 to FIG. 11, when user wants to draw the card 91 out, he/she only need to perform a reverse procedure of above. In the present invention, with the auto-eject device 41, as shown in FIG. 3, user only needs to push the card 91 that a recovery force of the spring 44 will move the sliding block 21 outwards to the eject position as shown in FIG. 8 and FIG. 9. When user draws the card 91 out, an edge of the lock hole 92 will press the inclined face 35 at the rear of the lock portion 34 to loose the lock portion 34 from the lock hole 91 that the card 91 may be drawn out of the card connector 10.

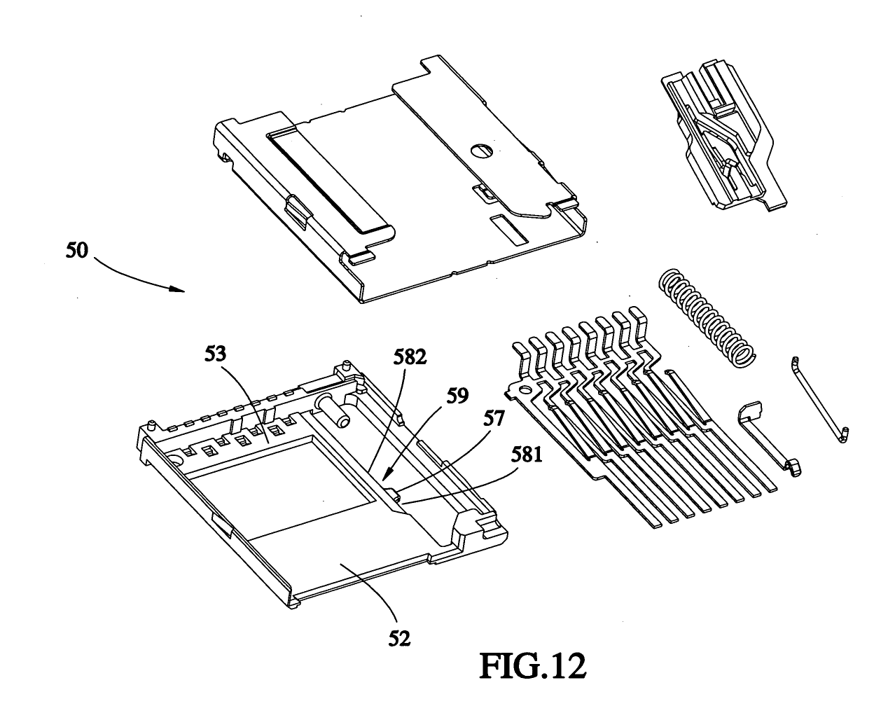

As shown in FIG. 12, a card connector 50 of the second preferred embodiment of the present invention, which is similar to the card connector 10 of the first embodiment, except that:

The substrate 52 forms a hollow portion 59 at a portion of the second side closing to the fixing terminal portion 59 and the protrusion 57 projecting to the hollow portion 59. The front space 581 and the rear space 582 are in the hollow portion 59 and at opposite sides of the protrusion 57.

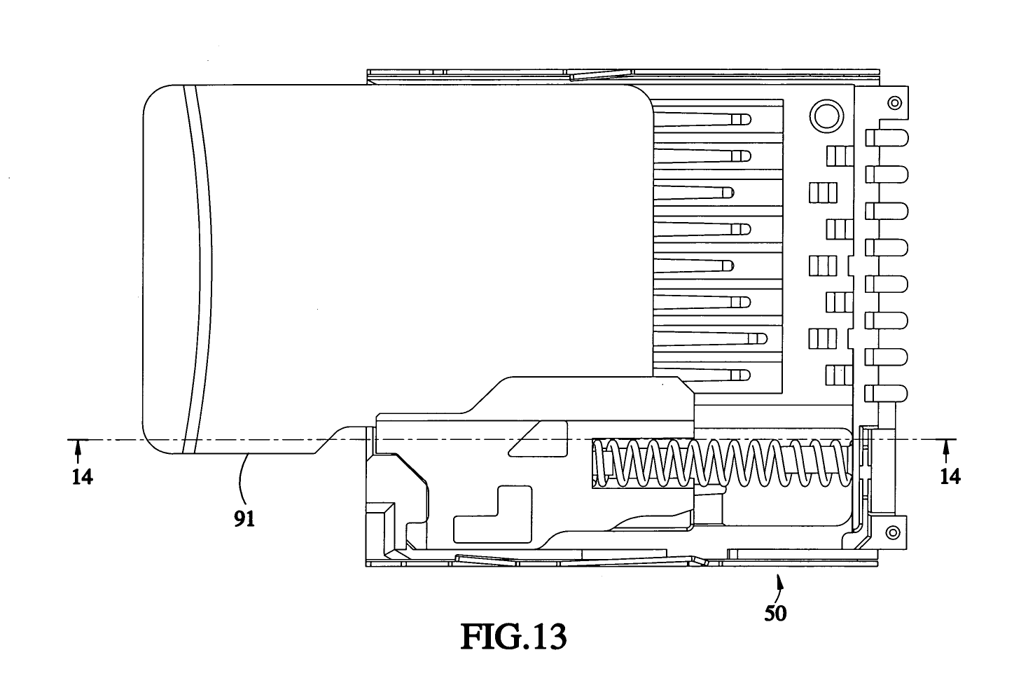

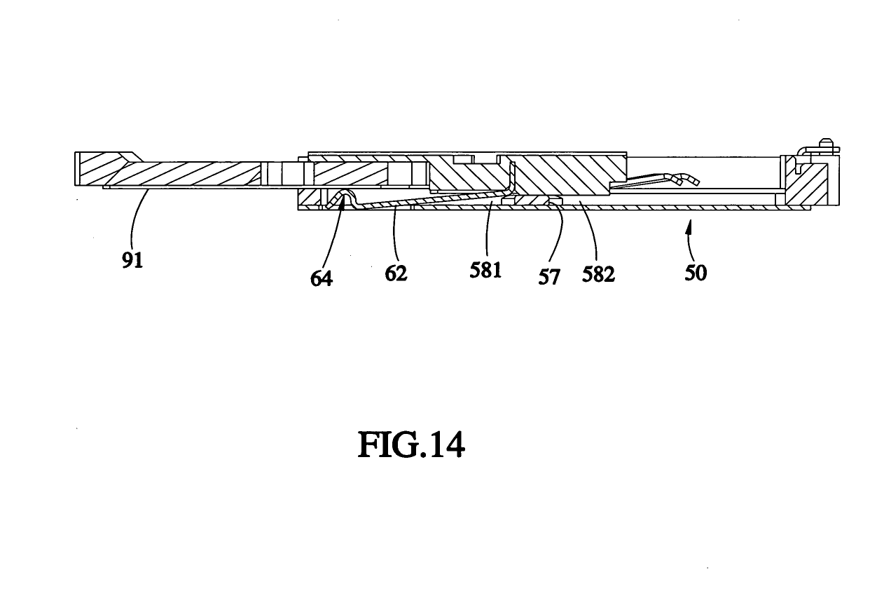

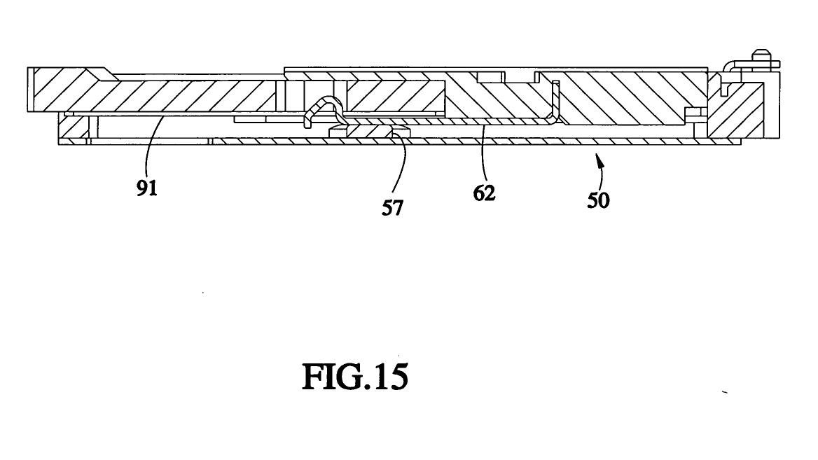

As shown in FIG. 13 and FIG. 14, when the card 91 is inserted, the lock portion 64 and the main member 62 are pressed and enter the front space 581. When reach the insert position, as shown in FIG. 15, the main member 62 is locked between the protrusion 57 and the card 91 to prevent it from moving up and down. The rest parts of the second embodiment are as same as the first embodiment, and we do not describe again.

In conclusion, the advantages of the present invention are:

1. Stably secure the card: the present invention provided the card locking the main member between the protrusion and the card to make sure the lock portion being locked in the lock hole of the card firmly that the card will be secured in the card connector completely without being affected by vibration and shake of the card connector. In addition, the structure of the present invention is different from the conventional card connectors.

2. Flexible space design: to compare with the prior art, the design of the protrusion and the front and rear spaces of the present invention provides the substrate with more hollow portion that the substrate may be more thinner to provides a flexible space design.

The description above is a few preferred embodiments of the present invention and the equivalence of the present invention is still in the scope of the claim of the present invention.

What is claimed is:

1. A card connector, which may secure a card inserted therein, comprising:
a housing including a substrate with a fixing terminal portion to mount a plurality of terminals thereon on a first side and a slot;
a sliding block, which has a pushing face to be acted with the card, received in the slot to be moved between an insert position and a eject position along the slot; and
a lock hook including a main member, a curved fixing piece projected from a rear of the main member and provided on the sliding block and a curved lock portion projected upwardly from a front of the main member;
wherein the substrate has a protrusion at a second side thereof adjacent to the fixing terminal portion and a front space and a rear space at opposite sides of the protrusion, and the main member of the lock hook is on the protrusion, and the main member of the lock hook leans on the protrusion and the lock portion is adjacent to the protrusion when the sliding block is moved to the insert position, and a rear section of the main member of the lock hook is on the protrusion and a front section thereof is in the front space and suspended when the sliding block is moved to the eject position.

2. The card connector as defined in claim 1, wherein the first side is a left side of the substrate and the second side is a right side thereof.

3. The card connector as defined in claim 1, wherein the protrusion has an inclined face at a front thereof.

4. The card connector as defined in claim 1, wherein the lock portion is a hook like member having two inclined faces sloping downward at a front and a rear thereof.

5. The card connector as defined in claim 1, wherein the substrate has a vertical table at the second side adjacent to the fixing terminal portion, and the protrusion is on the table, and the front space and the rear space are formed on the table and at the opposite sides of the protrusion respectively.

6. The card connector as defined in claim 5, wherein the table has a hollow portion in front of the protrusion.

7. The card connector as defined in claim 1, wherein the substrate has a vertical table at the second side adjacent to the fixing terminal portion, and the protrusion is projected from the substrate to the hollow portion, and the front space and the rear space are formed in the hollow portion and at the opposite sides of the protrusion.
